(19) United States
(12) Patent Application Publication
(10) Pub. No.: US 2026/0055653 A1
(43) Pub. Date: Feb. 26, 2026

(54) DOOR OPERATION BASED ON WEATHER DATA AND VEHICLE ORIENTATION

(71) Applicant: GM GLOBAL TECHNOLOGY OPERATIONS LLC, Detroit, MI (US)

(72) Inventors: Thiago Laserra LIMA, Sterling Heights, MI (US); Sitaram EMANI, Novi, MI (US); Carlos S. JABBOUR, Shelby Township, MI (US)

(21) Appl. No.: 18/812,578

(22) Filed: Aug. 22, 2024

(51) Int. Cl. E05F 15/71; E05B 81/56

(52) U.S. Cl. CPC E05F 15/71; E05B 81/56; E05Y 2900/531

(57) ABSTRACT

A control system for a vehicle including one of a window, a door, a rear hatch, or a deck lid that is selectively opened by at least one of a latch and an actuator. The control system includes a weather collecting module configured to receive a vehicle location generated by a GPS system of the vehicle and to retrieve weather data using a telematics system for the vehicle location. A controller includes a weather data processing module configured to receive the weather data and to adjust an operating parameter of at least one the at least one of the latch and the actuator in response to the weather data. The controller causes the at least one of the latch and the actuator to open the one of the door, the rear hatch, or the deck lid in response to an open command using the adjusted operating parameter.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to vehicle controllers, and more particularly to a controller configured to adjust operation of power windows, doors, a rear hatch, or a deck lid based on weather data and vehicle orientation.

Vehicles have been fitted with devices that enhance the user experience. Examples of these devices include power seats, power windows, and/or power door locks, which have made user interaction with vehicles easier. Power door locks operate with remote entry systems. A user operates a fob to unlock one or more vehicle doors. In some cases, operation of the fob to unlock the door also sets a selected seat position for the user. In other cases, the fob can be used to automatically open the vehicle door such as a hinged door, a sliding door, or a rear hatch or deck lid.

### SUMMARY

A control system for a vehicle including one of a window, a door, a rear hatch, or a deck lid that is selectively opened by at least one of a latch and an actuator. The control system includes a weather collecting module configured to receive a vehicle location generated by a global positioning system (GPS) system of the vehicle and to retrieve weather data using a telematics system for the vehicle location. A controller includes a weather data processing module configured to receive the weather data and to adjust an operating parameter of at least one the at least one of the latch and the actuator in response to the weather data. The controller causes the at least one of the latch and the actuator to open the one of the window, the door, the rear hatch, or the deck lid in response to an open command using the adjusted operating parameter.

In other features, the weather collecting module updates the weather data prior to entering a vehicle sleep mode. The weather collecting module updates the weather data during the vehicle sleep mode. The weather data processing module adjusts operating parameters for a plurality of doors, respectively, including the door based on the weather data.

In other features, a compass is configured to determine vehicle orientation. The weather data processing module adjusts the operating parameters for some of the plurality of doors differently than the operating parameters for others of the plurality of doors based on the vehicle orientation and the weather data.

In other features, the weather data processing module adjusts the operating parameters for some of the plurality of doors differently than the operating parameters for others of the plurality of doors based the vehicle orientation and wind direction specified in the weather data. The weather data processing module adjusts the operating parameters for some of the plurality of doors differently than the operating parameters for others of the plurality of doors based on the vehicle orientation and solar loading specified in the weather data.

In other features, a second actuator including a cylinder is configured to bias the one of the door, the rear hatch, or the deck lid to an open position. The weather data processing module is further configured to adjust an operating parameter of the second actuator in response to the weather data.

In other features, a compass is configured to determine vehicle orientation. The weather data processing module adjusts the operating parameter of the second actuator based on the weather data and the vehicle orientation.

In other features, the telematics system periodically wakes up during the vehicle sleep mode. The weather collecting module updates the weather data in response to the telematics system waking up.

A control system for a vehicle includes a weather collecting module configured to receive a vehicle location from a global positioning system (GPS) of the vehicle and to retrieve weather data for the vehicle location using a telematics system. A compass is configured to determine vehicle orientation. A controller includes a weather data processing module configured to receive the weather data and the vehicle orientation and to adjust an operating parameter of at least one a latch, an actuator, and a second actuator for at least one of a window, a door, a hatch, or a deck lid in response to the weather data and the vehicle orientation. The controller causes the at least one of the latch and the actuator to use the adjusted operating parameter in response to an open command.

In other features, the weather collecting module updates the weather data prior to entering a vehicle sleep mode. The weather collecting module periodically updates the weather data during the vehicle sleep mode. The weather data processing module adjusts operating parameters for a plurality of doors including the door. The weather data processing module adjusts the operating parameters for some of the plurality of doors differently than the operating parameters for others of the plurality of doors based on the weather data and the vehicle orientation. The weather data processing module adjusts the operating parameters for some of the plurality of doors differently than the operating parameters for others of the plurality of doors based on the weather data based on wind direction specified by the weather data.

In other features, the weather data processing module adjusts the operating parameters for some of the plurality of doors differently than the operating parameters for others of the plurality of doors based on the weather data based on solar loading specified by the weather data.

In other features, the second actuator includes a cylinder configured to bias the door to an open position. The weather data processing module is further configured to adjust an operating parameter of the second actuator in response to the weather data and the vehicle orientation.

In other features, the telematics system periodically wakes up during the vehicle sleep mode. The weather collecting module updates the weather data in response to the telematics system waking up.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a perspective view of a vehicle including a controller according to the present disclosure;

FIG. 2 is a block diagram illustrating a controller configured to adjust operation of power doors, a rear hatch, or a deck lid based on weather data and vehicle orientation for the vehicle of FIG. 1 according to the present disclosure;

FIG. 3 is a flow chart illustrating a method of collecting weather data prior to entering a vehicle sleep mode according to the present disclosure;

FIG. 4 is a flow chart illustrating a method of collecting weather data during the vehicle sleep mode according to the present disclosure; and

FIG. 5 is a flow chart illustrating a method of exiting the vehicle sleep mode and processing a door open command according to the present disclosure.

In the drawings, reference numbers may be reused to identify similar and/or identical elements.

### DETAILED DESCRIPTION

Vehicles that are parked outside may experience different weather conditions than those parked in a garage or other inside locations. For example, the vehicle may be parked in cold or hot ambient conditions such as freezing temperatures near or below 32ºF (or 0ºC) or hot temperatures around 100°F (37.8°C). Freezing temperatures may lead to icing conditions that may cause the doors to be frozen shut. Hot temperatures and/or solar loading may create a vapor lock and/or cause door seals to stick to one another which makes door opening difficult.

Controllers for electric motors associated with door, rear hatch, or deck lid actuators are typically designed to provide smooth operation during most weather conditions. However, the controllers may not supply sufficient torque needed to open a door, hatch or deck lid that is frozen shut or held closed by hot door seals. Some vehicles may include a second actuator (e.g., an ice breaker) that includes a cylinder that extends to provide additional opening force to open the door, hatch, or deck lid (for example during cold temperatures).

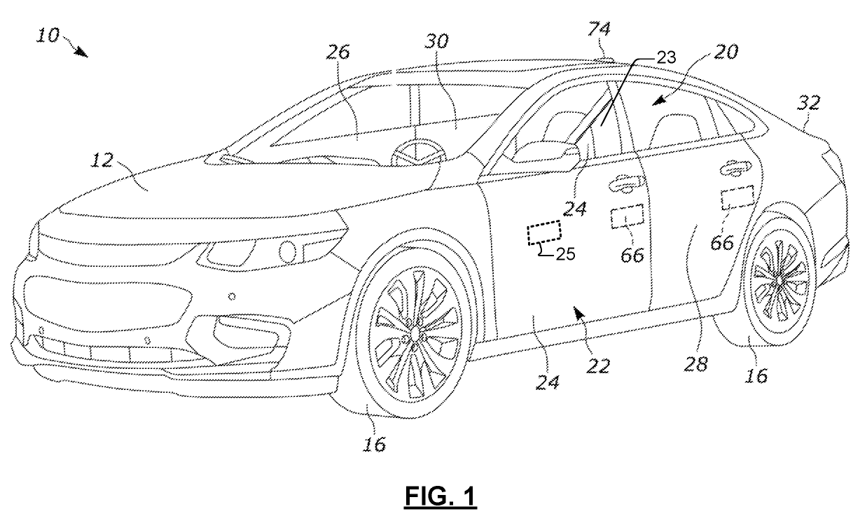

Referring now to FIG. 1, a vehicle 10 is shown to include a body 12 supported on a plurality of wheels 16. Body 12 defines, in part, a passenger compartment 20 that is accessible through doors 22 including windows 23. In some examples, doors 22 include a front left side or driver’s door 24, a front right side or passenger door 26, a rear left side passenger door 28, and a rear right side passenger door 30. In some examples, doors 22 include one or more sliding doors and/or one or more hinged doors. Vehicle 10 may also include a rear hatch 32 or deck lid to provide access to a rear storage area.

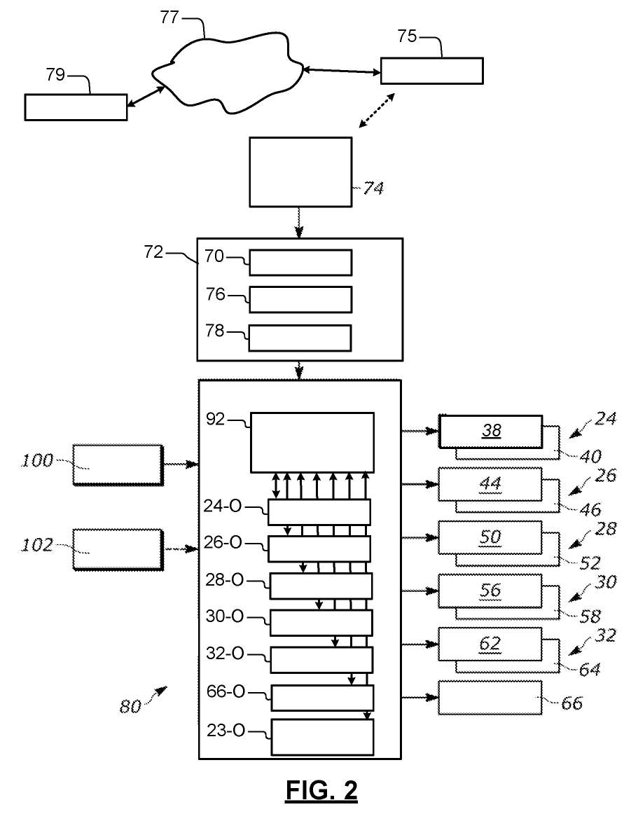

Referring to FIG. 2, front left side door 24 includes a first door latch 38 and a first door actuator 40. Door latches include a locking and latching mechanism that selectively prevents unauthorized access to passenger compartment 20. Door actuators include a motorized mechanism to provide unassisted opening and/or closing of the corresponding door. For example, the first door actuator 40 can include a direct drive electric motor or a motor connected through a linkage to the associated door.

Front right side door 26 includes a second door latch 44 and a second door actuator 46. Rear left side door 28 includes a third door latch 50 and a third door controller and actuator 52. Rear right side door 30 includes a fourth door latch 56 and a fourth door actuator 58. Rear hatch 32 includes a latch 62 and a hatch actuator 64. In other examples, the rear hatch 32 is replaced by a deck lid.

A second actuator 66 (e.g., an ice breaker) may be arranged at one or more of the vehicle doors 24, 26, 28, and/or 30 and/or the rear hatch 32 to provide additional opening force in the event that the corresponding actuator is unable to successfully open the door, rear hatch, or deck lid. Second actuator 66 includes a mechanically actuated cylinder that extends when actuated to provide additional opening force (e.g., when additional force is needed to overcome an icing condition or stuck door seals). As can be appreciated, windows 23 include actuators 25 that can use a similar approach for controlling the actuator 25.

With continued reference to FIG. 2, the vehicle 10 includes a telematics system 74 that enables wireless communications with a weather data server via a wireless communication system 75. Examples of the wireless communication system 75 include a cellular system, a satellite-based system, or another wireless communication system. In some examples, the wireless communication system 75 is connected to a distributed communications system (DCS) 77 such as the Internet. A weather data server 79 that is connected to the DCS 77 supplies current weather and/or weather forecast data in response to a request from the vehicle for weather data.

An infotainment system 72 or another controller of the vehicle 10 includes a global position system (GPS) 76 that is configured to provide GPS coordinates for the vehicle. The infotainment system 72 or another controller of the vehicle 10 includes a weather collecting module 70 that causes the telematics system 74 to retrieve weather data for the location of the vehicle using the telematics system 74. For example, the weather data that is collected may include current and forecasted temperature, precipitation, humidity, sun trajectory and/or angle, cloud condition data, wind speed and direction, and the like.

The infotainment system 72 or another controller of the vehicle 10 includes a compass 78 that is configured to determine the orientation of the vehicle at the vehicle location (e.g., the vehicle is oriented at a particular angle relative to a coordinate system). As will be described further below, the orientation of the vehicle and the weather forecast are used to adjust door, rear hatch, and/or deck lid operating parameters for opening one or more of the doors, rear hatch and/or deck lid of the vehicle.

In some examples, the weather collecting module 70 causes a weather data request including the GPS coordinates of the vehicle (or more generalized vehicle location data) to be transmitted via the telematics system 74 to the weather data server 79. The weather data server 79 replies by transmitting the current and/or forecasted weather data for the vehicle location back to the vehicle via the DCS 77, the wireless communication system 75, and the telematics system 74.

Vehicle 10 includes a controller 80 that requests the weather data at intervals or in response to an event, selectively adjusts operating parameters for the actuators and latches based on the weather data and the vehicle orientation, and selectively triggers actuators and latches for one or more of the doors 22 and/or rear hatch 32 in response to an open command from the operator. While a single controller 80 is shown for controlling all of doors 22 and rear hatch 32 of the vehicle 10, one or more additional controllers 80 can be used. Controller 80 stores a set of instructions and operating parameters for operating each of the doors 22, rear hatch 32, and/or the second actuators 66 based on the weather data and the vehicle orientation as will be described further below.

In some examples, open commands are received through a hard wired switch 100 provided on vehicle 10 or through a wireless input provided by a fob 102. The controller 80 causes the latches and the actuators to unlatch and open selected ones of the doors 22 or the rear hatch 32. Controller 80 optimizes control parameters associated with opening of the doors 22, the rear hatch 32, and/or the second actuator(s) 66 based on the weather data and orientation of the vehicle.

Controller 80 receives the weather data from the weather collecting module (WCM) 70 at predetermined intervals, in response to an event, or using other criteria. For example, the telematics system 74 typically wakes up and communicates wirelessly with remote servers on a periodic basis. In some examples, the controller 80 aligns timing of weather data updates with the automatic wake-up periods of telematics system 74 to reduce battery drain.

A weather data processing module (WDPM) 92 of the controller 80 receives the weather data and selectively adjusts the weather data for the doors and/or hatch based on the orientation of the vehicle. For example, doors on one side of the vehicle may be exposed to wind or solar loading which may affect the opening of the corresponding door(s).

The weather data processing module (WDPM) 92 adjusts and stores operating parameters 24-O, 26-O, 28-O, 30-O, 32-O, 66-O, and 23-O in non-volatile memory for the latch and actuators corresponding to the doors 24, 26, 28, 30, the rear hatch 32, the second actuator 66, and/or the window 23, respectively. In some examples, the operating parameters are transmitted to the latches and actuators. In some examples, the operating parameters include door latch parameters, door actuator parameters (e.g., current magnitude, current timing, current waveform shape), delay between door latch and door actuator initiation, delay or counts after attempting to open the door or rear hatch before initiating the second actuator, and/or other parameters.

For example, the vehicle 10 may be parked outside in the cold temperatures near freezing. Prevailing winds may be blowing approximately normal to the passenger side of the vehicle and precipitation is forecasted. The controller 80 receives the weather forecast, evaluates the weather data, determines that there is a high probability that all doors and the rear hatch or a subset thereof (e.g., just the passenger doors) may be stuck closed due to accumulation of ice. For example, the controller 80 (or the WDPM 92) updates and stores adjusted door seal break, stall detection, and/or timing parameters for the primary and/or second actuator(s).

The controller 80 adjusts one or more operating parameters. Examples include increasing current magnitude or a shape of the current waveform to be supplied to the door or rear hatch actuator(s), increasing or decreasing the number of failed attempts to open the door or rear hatch before causing other events to occur (such as actuating the second actuator), and/or setting or adjusting other operating parameters of the door, the rear hatch, and/or the second actuator. As can be appreciated, the controller 80 may control some or all of the doors and/or the rear hatch using the same operating parameters. In other examples, the operating parameters may be adjusted differently based on the orientation of the vehicle relative to the sun, wind, or other asymmetric weather conditions.

For example, the vehicle may be parked outside in the hot temperatures with high solar loading on the passenger side of the vehicle. Prevailing wind speed may be low. The controller 80 receives the weather forecast, evaluates the weather data, determines that there is a high probability that all doors (or just the passenger doors due to the orientation of the sun) may be stuck closed by the seals. In some examples, the controller 80 increases the magnitude supplied current, alters the current waveform or timing of the current supplied to the door actuator, and/or sets or adjusts parameters for the second actuator 66 associated with the passenger door(s).

As can be appreciated, seal load parameters are adjusted based on hot or cold weather conditions. For example, the seal load operating parameters are adjusted to apply variable attenuation on current spikes that occur due to excessive current load when breaking open the door seals. Activation timing of second actuator(s) 66 is adjusted for cold weather conditions. In other words, the delay period before initiating the second actuator may be reduced.

The delay between the start of power door motion relative to the latch release status may be adjusted for both hot and cold weather conditions to improve door operation in cold/hot weather conditions. For example, the elasticity of the seals changes with temperature. Depending on the door and seal types, the power door control system may globally adjust motor stall parameters in response to the number of power door motion events within a predetermined period (e.g., 30 minutes). The number of activations within the predetermined period changes how the door seal reacts to a motion start event.

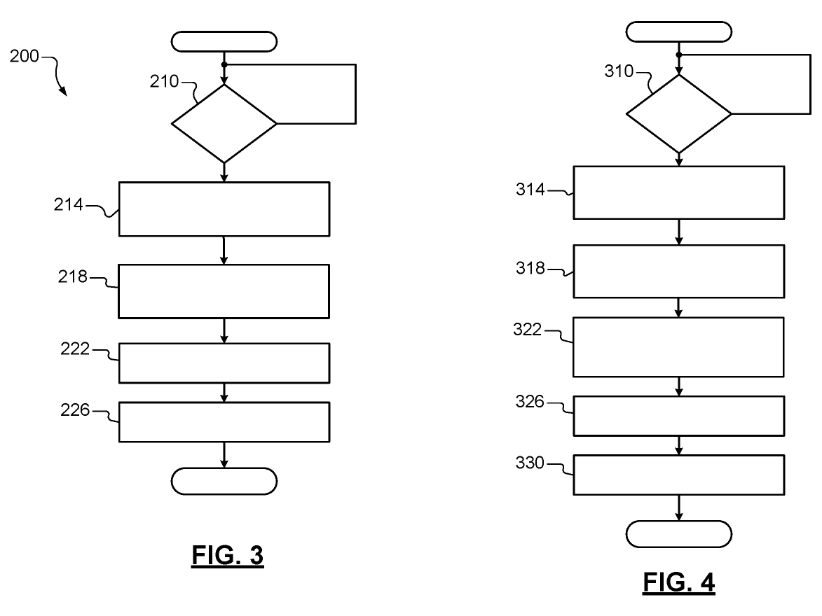

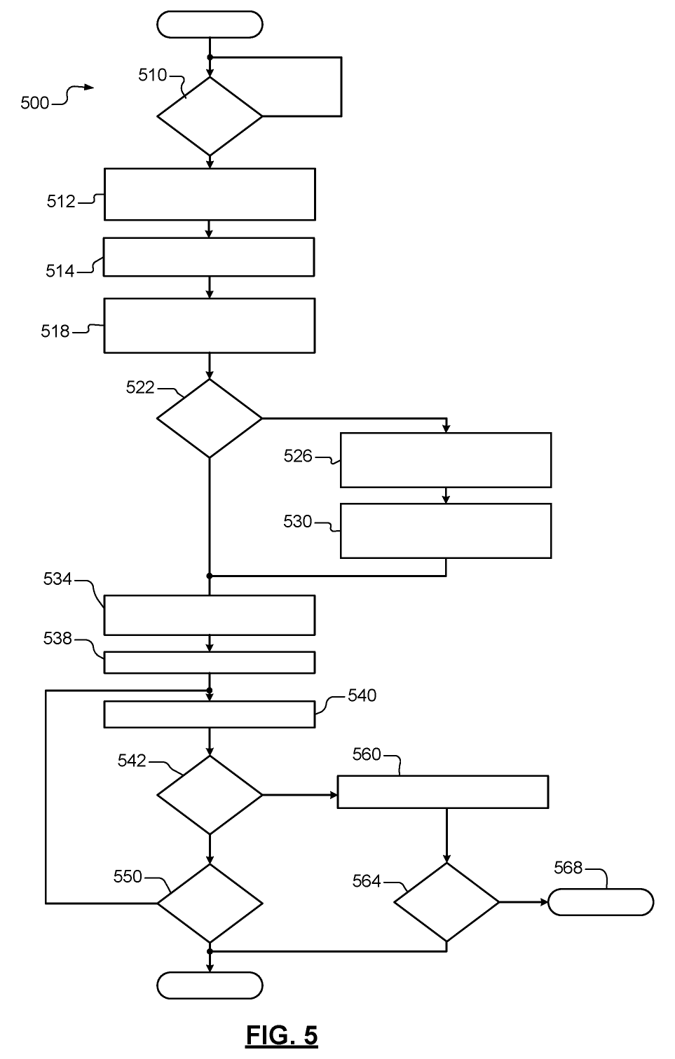

Referring now to FIGS. 3 and 4, the weather data is updated prior to the vehicle entering the sleep mode and at periodic intervals while the vehicle is in the sleep mode so that the vehicle is ready when the open door command is received. In FIG. 3, a method 200 for entering a vehicle sleep mode when the vehicle is parked is shown. At 210, the method determines whether the vehicle is entering a sleep mode (e.g., vehicle parked, engine turned off, occupants exit, and/or vehicle is locked (although other criteria can be used)). If true, the method uses GPS 76 and telematics system 74 to retrieve weather data for the vehicle location at 214. At 218, the GPS 76 or the controller 80 adjusts the weather data corresponding to each of the doors or hatch based the orientation of the vehicle determined by the compass 78. At 222, the adjusted weather data is stored in the controller 80 or another suitable location for each of the doors and/or hatch. At 226, the sleep mode of the vehicle is enabled.

In FIG. 4, during extended parking periods, weather data updates may be triggered after a predetermined period or an event occurs (e.g., during a telematics synchronization event). At 310, the vehicle determines whether the weather forecast update event occurs. If 310 is true, vehicle wakes up GPS 76, controller 80, compass 78, and/or other system components supporting weather data retrieval and adjustment at 314.

At 318, the method causes GPS 76 and telematics system 74 to retrieve updated weather data for the vehicle location at 318. At 322, the GPS 76 or the controller 80 updates the weather data and/or adjusts the weather data corresponding to each of the doors or hatch based on the orientation of the vehicle determined by compass 78. At 326, the weather data for each of the doors and/or hatch is stored in a non-volatile memory in the controller 80 or in another suitable location. At 330, the sleep mode of the vehicle is enabled.

Referring now to FIG. 5, the method 500 determines whether an open door or hatch command is received. If 510 is true, the method wakes up weather collecting module 70, telematics system 74, GPS 76, compass 78, controller 80, and/or other system components at 512. At 514, GPS 76, telematics system 74, and/or weather collecting module 70 retrieve the weather data to provide an updated forecast. At 518, the door open/close cycle counts are retrieved for a prior predetermined period. Depending on the door and seal types, the controller globally adjusts the motor stall parameters based on the number of power door motion events in the last period (e.g., 30 minutes or another period). The number of activations affects how the door seal responds to motion start.

At 522, if a new weather forecast is available, the weather data is retrieved and stored. In some examples, the weather data is adjusted based on the vehicle orientation and the operating parameters are adjusted. For example at 526, operating parameters such as the door seal break, stall detection, and/or timing of the primary and/or second actuators are adjusted and stored. For example at 530, operating parameters such as the door seal break, stall detection, and/or timing of second actuator 66 are adjusted and stored.

If new forecast data is not available, the previously stored forecast is used assuming that the stored forecast covers the opening period. The method continues from 522 (if false) or from 530 with 534. At 534, the method uses the adjusted operating parameters for opening the door or hatch. For example, the load current door profile and current stall profile are loaded for the actuator. At 538, the unlatch time is started for the selected door. At 540, the controller attempts to unlatch the selected door or hatch.

At 542, the method determines whether the latch is stuck closed for a period greater than a predetermined threshold (T_{TH}). If 542 is false, the method determines whether the latch is open at 550. If 550 is false, the method returns to 540. If 542 is true, the method continues at 560 and initiates opening of the door or hatch with the second actuator. At 564, the method determines whether the latch is open. If 564 is true, the method ends. If 564 is false, then a fault is triggered or other action is taken at 568 such as repeating one or more portions of the method.

In accordance with the present disclosure, the controller 80 adjusts door operating parameters in response to weather data and/or vehicle orientation. For example, if the environmental information indicates freezing temperatures and precipitation, rapid activation of the latch and actuator may be indicated. For example, the controller 80 may adjust an output current profile and/or timing for the doors or rear hatch.

The operating parameters are adjusted depending on vehicle orientation. For example, the doors 22 on one side of the vehicle can be exposed to wind and precipitation while at freezing temperatures prior to the open command. The other doors on the opposite side of the car may not be exposed to wind or may be exposed to solar loading on one side of the vehicle. The controller 80 increases the current magnitude or adjusts the current waveform to provide more power to open the doors that are more likely to be stuck (relative to the other doors that are not). The higher current magnitude or more aggressive current profile may be used to break the ice and open the doors 22. The approach may be repeated one or more times before the second actuator 66 is used.

In warmer conditions, the application of current to the corresponding door latch may be substantially instantaneous. However, the forecasted temperature and/or sun loading may indicate that the seals may be sticking. In some examples, the current can be increased or ramped up more slowly to open the doors that may be stuck closed due to warm seals.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information, but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (a) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, Oval, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A control system for a vehicle including one of a window, a door, a rear hatch, or a deck lid that is selectively opened by at least one of a latch and an actuator, the control system comprising:
a weather collecting module configured to receive a vehicle location generated by a global position system (GPS) system of the vehicle and to retrieve weather data using a telematics system for the vehicle location; and
a controller including a weather data processing module configured to receive the weather data and to adjust an operating parameter, including at least one of increasing current magnitude and changing a current waveform shape of electrical current distributed to the at least one of the latch and the actuator in response to the weather data,
wherein the controller causes the at least one of the latch and the actuator to open the one of the window, the door, the rear hatch, or the deck lid in response to an open command using the adjusted operating parameter.

2. The control system of claim 1, wherein the weather collecting module updates the weather data prior to entering a vehicle sleep mode.

3. The control system of claim 2, wherein the weather collecting module updates the weather data during the vehicle sleep mode.

4. The control system of claim 1, wherein the weather data processing module adjusts operating parameters for a plurality of doors, respectively, including the door based on the weather data.

5. The control system of claim 4, further comprising a compass configured to determine vehicle orientation.

6. The control system of claim 5, wherein the weather data processing module adjusts the operating parameters for some of the plurality of doors differently than the operating parameters for others of the plurality of doors based on the vehicle orientation and the weather data.

7. The control system of claim 5, wherein the weather data processing module adjusts the operating parameters for some of the plurality of doors differently than the operating parameters for others of the plurality of doors based the vehicle orientation and wind direction specified in the weather data.

8. The control system of claim 5, wherein the weather data processing module adjusts the operating parameters for some of the plurality of doors differently than the operating parameters for others of the plurality of doors based on the vehicle orientation and solar loading specified in the weather data.

9. The control system of claim 1, further comprising:
a second actuator arranged in the one of the window, the door, the rear hatch, or the deck lid, the second actuator including a cylinder configured to bias the one of the door, the rear hatch, or the deck lid to an open position,
wherein the weather data processing module is further configured to adjust an operating parameter of the second actuator in response to the weather data.

10. The control system of claim 9, further comprising:
a compass configured to determine vehicle orientation,
wherein the weather data processing module adjusts the operating parameter of the second actuator based on the weather data and the vehicle orientation.

11. The control system of claim 3, further comprising:
the telematics system,
wherein the telematics system periodically wakes up during the vehicle sleep mode, and
wherein the weather collecting module updates the weather data in response to the telematics system waking up.

12. A control system for a vehicle, comprising:
a weather collecting module configured to receive a vehicle location from a global positioning system (GPS) of the vehicle and to retrieve weather data for the vehicle location using a telematics system;
a compass configured to determine vehicle orientation; and
a controller including a weather data processing module configured to receive the weather data and the vehicle orientation and to adjust an operating parameter, including at least one of increasing current magnitude and changing a current waveform shape of electrical current distributed to the at least one of a latch, an actuator, and a second actuator for at least one of a window, a door, a hatch, or a deck lid in response to the weather data and the vehicle orientation,
wherein the controller causes the at least one of the latch, the actuator, and the second actuator to use the adjusted operating parameter in response to an open command.

13. The control system of claim 12, wherein the weather collecting module updates the weather data prior to entering a vehicle sleep mode.

14. The control system of claim 13, wherein the weather collecting module periodically updates the weather data during the vehicle sleep mode.

15. The control system of claim 12, wherein the weather data processing module adjusts operating parameters for a plurality of doors including the door.

16. The control system of claim 15, wherein the weather data processing module adjusts the operating parameters for some of the plurality of doors differently than the operating parameters for others of the plurality of doors based on the weather data and the vehicle orientation.

17. The control system of claim 15, wherein the weather data processing module adjusts the operating parameters for some of the plurality of doors differently than the operating parameters for others of the plurality of doors based on the weather data based on wind direction specified by the weather data.

18. The control system of claim 15, wherein the weather data processing module adjusts the operating parameters for some of the plurality of doors differently than the operating parameters for others of the plurality of doors based on the weather data based on solar loading specified by the weather data.

19. The control system of claim 12, wherein
the second actuator is arranged in the one of the window, the door, the hatch, or the deck lid,
wherein the second actuator includes a cylinder configured to bias the door to an open position, and
wherein the weather data processing module is further configured to adjust the operating parameter of the second actuator in response to the weather data and the vehicle orientation.

20. The control system of claim 14, further comprising:
the telematics system,
wherein the telematics system periodically wakes up during the vehicle sleep mode, and
wherein the weather collecting module updates the weather data in response to the telematics system waking up.
